(19) United States
(12) Patent Application Publication
(10) Pub. No.: US 2016/0132807 A1
(43) Pub. Date: May 12, 2016

(54) Method for Managing Signing Agents

(71) Applicants: Charles J. Camenzind, Tempe, AZ (US); Spencer T. Brown, Salt Lake City, UT (US)

(72) Inventors: Charles J. Camenzind, Tempe, AZ (US); Spencer T. Brown, Salt Lake City, UT (US)

(21) Appl. No.: 14/884,505

(22) Filed: Oct. 15, 2015

Related U.S. Application Data
(63) Continuation-in-part of application No. 14/535,023, filed on Nov. 6, 2014.

(51) Int. Cl. G06Q 10/06; G06F 21/31; G06Q 30/04; G06Q 10/10; G06F 17/24; G06Q 50/18; G06F 3/0482; G06F 17/22; G06F 3/0484; G06F 21/62; G06Q 50/16

(52) U.S. Cl. CPC G06Q 10/06313; G06F 21/6218; G06F 21/31; G06Q 30/04; G06Q 10/107; G06Q 50/16; G06Q 50/18; G06F 3/0482; G06F 17/2235; G06F 3/04842; G06F 17/24

(57) ABSTRACT

The embodied invention is a software system in a central computer that facilitates scheduling of a high volume of meetings among a wide array of individuals and companies with important secure methods for managing documents requiring a notarized signature or third party document exchange. The schedule is run from a central location where individual notaries attend signing appointments. Important convenience features are included that facilitate the volume of meetings and the accuracy needed to transfer signed legal documents to the correct authority in a timely manner.

### CROSS REFERENCE TO RELATED APPLICATIONS

This application is a continuation in part of patent application Ser. No. 14/535,023 filed on Nov. 6, 2014. The entire prior referenced application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed at management methods for signing agents, in particular for notaries who are authorized to notarize and manage important documents with sensitive and personal information.

(2) Description of Related Art

The purpose of a real estate closing is to sign and disperse all the needed documents that convey title, attach the lender to the property, disperse money, and deal with any other issues agreed to by the parties involved. A closing statement is prepared by an Escrow Officer according to a standard such as the current “HUD-1.” The closing statement includes various fees and charges such as the mortgage lender's fees, document preparation, title company's fees, court recording costs, taxes, and various mortgage payoffs, among others. The amount of paperwork at a real estate closing can be very significant; often 75-200 pages that need to be properly signed, reviewed, and returned to the Title Company. A notary can also be needed at the sale of an automobile or other property to perform similar functions such as witnessing attorney created documents related to a transaction, loan, or sale.

It is desirable to provide a basis for a Signing Company to increase its order processing capabilities in various industries by making normal tasks automated, convenient, and efficient. With a high volume of orders comes an increased volume of taking orders, scheduling, orders, rescheduling orders, sending document packages, sending updated document packages, sending notes, and sending updated notes. Also it is important to know the status/progress of an order at all times as well as knowing the current status of the documents.

All documents need to be signed accurately and returned quickly. Most closings have proration dates and potential financial penalties for any delays. When a closing is delayed many parties can be affected. It is desirable to have the ability to confirm document progress, including an assurance that all documents will be present at the closing for signature.

At a real estate closing, the title company will collect the monetary funds from the buyer and lender as well as the settlement costs from each party. With these funds in hand, the title company then pays all of the expenses of the transaction, pays off any existing mortgages, and pays the seller the net proceeds of sale. All of this is done in accordance with the closing (such as HUD-1) settlement statement.

It is important that the documents are signed properly and the money is dispersed accurately. A notary can be employed by the Title Company to handle the closing (i.e. notarize the signatures, collect the signed documents, collect the money, and send them to the Title Company).

However, a Title Company will desire to employ a reliable subcontractor (Signing Company) that handles the transactions in their behalf. The Signing Company must act as a “Signing Agent” on behalf of the Title Company. The Signing Company then employs a notary who directs and occasionally coordinates the closing meeting(s). The Signing Company may employ a number of notaries who then carry out the Signing Agent duties required by the Title Company and the Escrow Officer. Since the Signing Company receives a relatively small fee for most signing events, a large number of transactions are required to fund even a small Signing Company of several employees.

FIG. 1 is a prior art example of a manual log that a notary would use as part of notary duties. Note the amount of information on the form dedicated to identifying the persons signing the document.

As part of a real estate closing, typical, but not all, documents that a Signing Agent will receive and forward to the Title Company:

1) Deed. The document that transfers the property from the seller to the buyer.

2) Bill of sale. This describes and transfers all of the property that is being sold along with the house, such as furnaces, air conditioners, appliances, etc. per the sales contract.
3) Seller's affidavit. A document whereby the seller confirms ownership of the property and discloses any important legal and financial issues attached to the property.
4) Real estate tax documents.
5) Buyer/seller settlement statement (such as HUD-1). An itemized financial statement for fund receipts and payments to the parties.
6) Mortgage/Loan Documents. Loan agreement between buyer and lending bank including truth in lending disclosure and financial terms.
7) Identification documents (copies of passports, driver's licenses, birth certificates etc.)
8) Property survey or a legal description of the property being sold.
9) Inspection reports.
10) Other documents that need to be recorded, signed, or copies to be retained by the individual parties involved.

A notary employed (or sub-contracted) by a Signing Company typically attends three or four signing appointments (notary signing events) per day, depending upon the type of documents to be notarized. Dozens of notaries are capable of being scheduled and managed by the embodied method with minimal staffing at the Signing Company. If the Signing Company is suitably staffed, and is utilizing a scheduling management system, hundreds or even thousands of notaries are capable of being scheduled each day and the associated documents are handled securely and properly.

Others have worked in the field of organizing contract documents and working with multiple contractors. For example, US 20070078771 discloses a software system for construction management of multiple companies for payments against large invoices and the creation of a project management organization among the parties. However, it is designed to manage a relatively low volume of companies with large payments for each transaction. Such construction management software is not designed to handle the high level of frequent changes in paperwork, schedule changes, the need to confirm many important details quickly, and confirm important details in a rapidly changing environment. Further, such software is not designed for a high volume of meetings that are scheduled among many different individuals with a relatively small payment from each meeting. Important convenience features are not included that facilitates execution so that the process of completion is simplified, and fast timing and accuracy are maintained at a very high level. For example, if the notary makes a critical mistake with respect to the documents, it may mean that a buyer will miss a critical deadline for a loan with potential interest penalties.

What is needed is a is a method that facilitates scheduling of a high volume of meetings among a wide array of individuals and companies with important secure methods for managing sensitive documents that require a notarized signature.

### BRIEF SUMMARY OF THE INVENTION

The embodied invention is a method that utilizes a central computer to facilitate scheduling of a high volume of constantly changing meetings among a wide array of individuals and companies with important secure methods for managing documents requiring a notarized signature or third party document exchange. The meeting schedule is run from a central computer system where individual notaries agree to signing appointments and closings of which details are constantly changing. Important convenience features are included that facilitate the volume of meetings and the accuracy needed to transfer signed legal documents with sensitive and personal information to the correct authority.

### BRIEF DESCRIPTION OF THE SEVERAL VIEWS OF THE DRAWING(S)

FIG. 1 shows a manual prior art method of how a notary would keep track of signing records.

FIG. 2 shows the hardware used for scheduling and document tracking, including invoicing in an embodiment of the invention.

FIG. 3 shows a simplified hardware view of the scheduling and document tracking in an embodiment of the invention.

FIG. 4 shows the administrative screen for live orders.

FIG. 5 shows the entry screen for a new order.

FIG. 6 shows the administrative screen for vendors.

FIG. 7 shows the vendor input screen for administrative staff.

FIG. 8 is the administrative screen for users, including Vendors such as notaries, Administrative, and Customers such as Escrow Officers.

FIG. 9 is an input screen for new users.

FIG. 10 is an input screen for new users showing a popup window highlighting database contact information for the assigned notary.

FIG. 11 is an input screen for new users showing a popup window highlighting database contact information for the escrow officer.

FIG. 12 is an input screen for new users showing a popup window highlighting database choices for the assigned notary.

FIG. 13 is a customer screen which is available to a customer for viewing an order.

### DETAILED DESCRIPTION OF THE INVENTION

The embodied invention incorporates a number of particular features which facilitate the timeliness and success of financial and property transactions. It is important that the computer implemented system is simple, accurate, and efficiently provides for signing appointment scheduling and document tracking.

Because it is desirable to coordinate a large number of notaries with a large number of meetings, it is important that a simplified user interface is provided so that there is minimal training on the central computer system. Additionally, it is expected that there will always be notary turnover making minimal training highly desirable.

The method to do this is also designed to achieve a high success rate by timely tracking documents that have to be filed, recorded, or submitted to the final destination. Important automated prompts and convenience buttons are included in the software that are based on document timeliness to ensure that users are notified promptly of any deficiencies, so immediate corrective action is possible with routine communication to every vendor automated to a high degree.

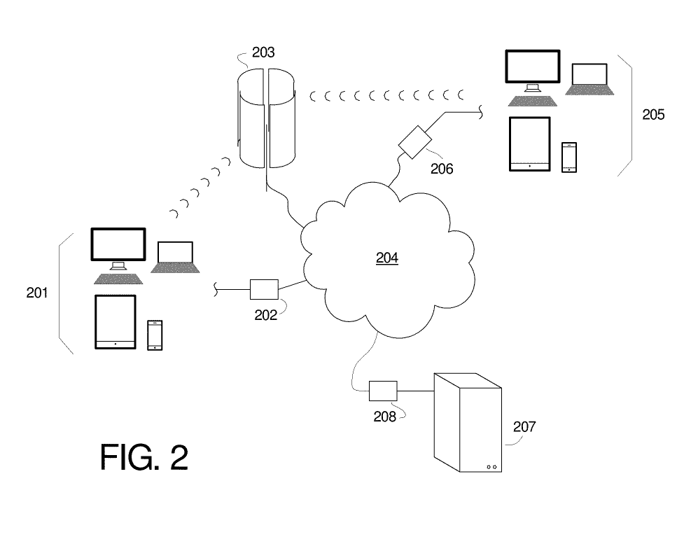

FIG. 2 is an exemplary embodiment of the invention showing how various inputs are made to the central computer system 207 (or server) where the database resides. Various types of data entry hardware 201 for the Signing Agent are used by multiple individuals and communicate the central computer 207 through the internet 204. The data entry hardware 201 can comprise a number of convenient devices in use by various notaries, such as mobile devices (cell phones and the like) as well as other mobile devices such as tablet computers and mobile phones with internet browsers built in. The Signing Agent (i.e. notary) or Escrow Officer (EO) interfaces with the database by the data entry hardware 202 through a modem/router interface to the internet (alternately, they interface to the internet through a cell tower 203). Similar data entry hardware 205 and associated modem router interface 206 connect to the internet and is used by the Signing Company. The database is designed to be accessed through a router 208 or similar equipment and resides on the central computer system 207. The data entry hardware connects to the central computer through the internet.

The electronic communication between users and the central computer system includes a secure encrypted connection when viewing or accessing data and documents residing in the central computer system.

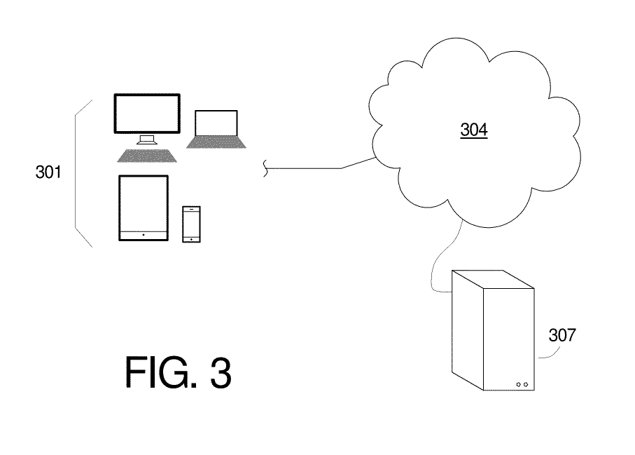

FIG. 3 is a further simplification of the browser interface to the central computer system and associated database. Central computer system users, of varying kinds, such as Escrow Officers, Notaries, Signing Companies, and Title Companies all access the database/central computer system 307 through the internet 304 utilizing their preferred hardware device 301 with an internet browser incorporated in it. It does not matter what hardware is used and which path is taken through the internet provided the user has a compatible web browser. The central computer system 307 also interfaces to the internet and manages the login and password information for the central computer system users. Browser software is used as the interface backbone for the users of the central computer system. A web browser (commonly referred to as a browser) is a software application for retrieving, presenting and traversing information resources on the World Wide Web. The central computer system uses specialized database software or highly customized software.

In an alternate embodiment, the central computer system may reside on more than one computer at more than one geographic location. It is possible to have the user interface programming reside in one computer in one location, and the database reside in a second computer at a second location. The central computer system would generally include at least one CPU, transient and non-transient memory, and an operating system that would allow the CPU to be programmed to carry out a set of arithmetic or logical operations automatically. The parts of the computer do not have to be at one geographic location.

As used herein the terms central computer and computer system are intended to refer to a computer-related entity, comprising either hardware, a combination of hardware and software, software, or software in execution capable of performing the embodiments described. The disclosed embodiments which use the central computer refer to being interfaced to and controlled by a computer readable storage medium having stored thereon a computer program. The computer readable storage medium may include a plurality of components such as one or more of electronic components, hardware components, and/or computer software components. These components may include one or more computer readable storage media that generally store instructions such as software, firmware and/or assembly language for performing one or more portions of one or more implementations or embodiments of an algorithm as discussed herein. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or solid-state or electronic memory. Other forms of non-transitory and/or tangible computer readable storage media not list may be employed with the disclosed embodiments.

A number of such components can be combined or divided in an implementation of a computer system. Further, such components may include a set and/or series of computer instructions written in or implemented with any of a number of programming languages, as will be appreciated by those skilled in the art. Computer instructions are executed by at least one central processing unit. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

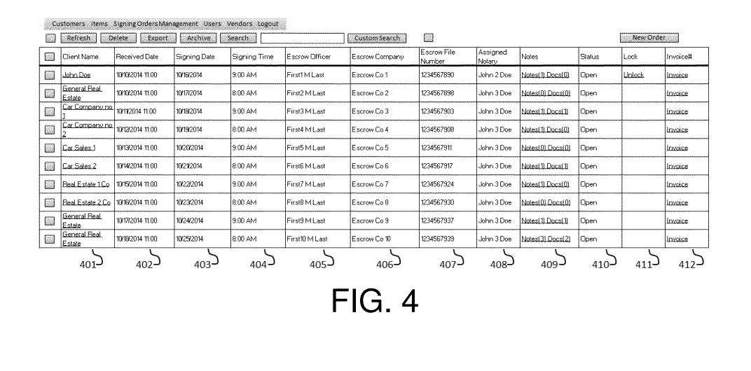

FIG. 4 shows the administrative screen for live orders which provides certain administrative updating, editing, and status monitoring functions. Included are information data fields related to an order that is submitted by the Escrow Officer: client name 401, received date 402, signing date 403, signing time 404, escrow officer 405, escrow company 406, escrow file number field 407, assigned notary 408, notes 409, status open (open closed) 410, lock (lock/unlock) 411 and invoice number (number and link to invoice) 412. The lock/unlock 411 tells the admin user that the order is being edited by another admin user or the customer such as the Escrow Officer.

Additionally, the user has a refresh button to reload the screen and confirm any changes along with a refresh check box that causes the system to automatically refresh when there is a change or something new is added. A delete button is available to start a process to remove an order, an export button sends the order information to an external file, an archive button sends the order to archive status (which removes the record from the administrative screen and deletes attached documents for security reasons), and a custom search button locates order(s) according to a criterion, which includes archived orders, and display the results on the screen. A quick search is a keyword search based on all parameters (i.e. all database fields). A custom search is a keyword search of a particular database field that is selectable by the person doing the search.

In an alternate embodiment of the invention, multiple layers of permissions (for security) are given to administrative staff. For example, one staff person is able to delete and change an order, but another staff person is only able to schedule an order.

In another embodiment of the invention, administrative staff can send out emails to a large group of people. For examples vendors may need to be notified of a new delivery method. In this case, the administrative staff can select a particular group in the central computer database to be notified via email and conveniently notify all parties in that group.

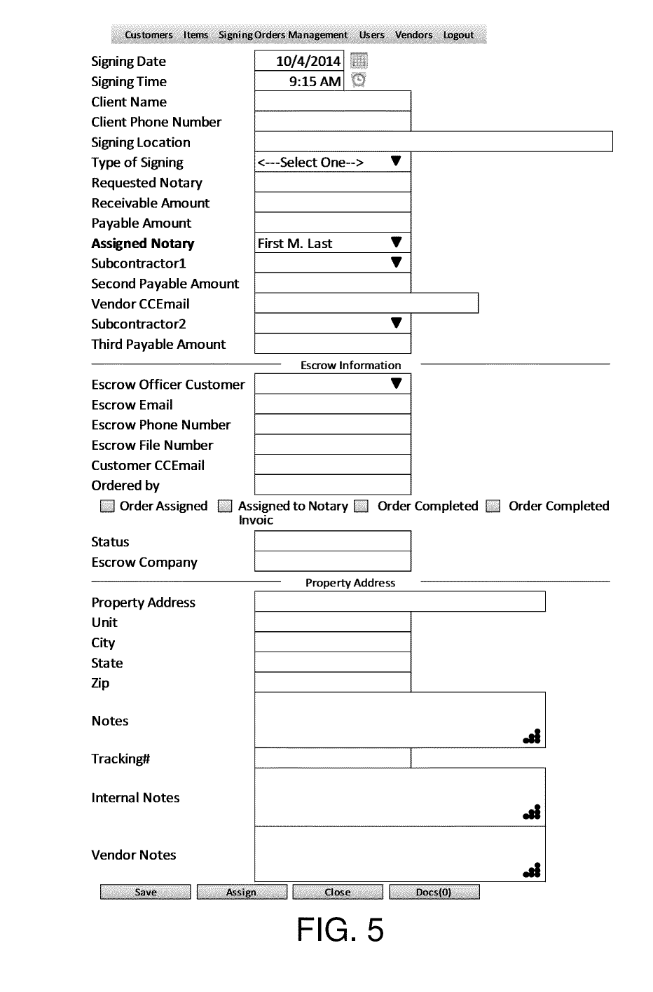

FIG. 5 shows the entry screen for a new order. A new order (for a signing appointment) is input by the data fields shown, many of which are on FIG. 4. The receivable amount is the payment amount for the Signing Company and the payable amount is the amount paid to the Notary. The type of signing, assigned notary, second and third assigned notary (for sales and commissioned representatives), and escrow officer customer are drop down menus as indicated by the small filled in triangle, which are fillable only by selecting a choice presented by the central computer. A new order cannot change the available entries for these fields.

In FIG. 5 it is important to note the following:
1) The signing date, time and location can be determined by the customer, or it can be left to admin to schedule.
2) The type of signing is selectable from a customizable list of items/signing types that have unique specifications. The list of signings allows administrative staff to assign a particular type based on other signing variables such as company preferences on contract amounts different than other companies. The contract amount then populates elsewhere in the order when a signing type is selected. It can also be edited to offer a discount or to include charges such as extra travel by the notary, excessive number of documents, and other items.
3) Vendor carbon copy e-mail allows the “Assigned Email” to be sent to any subcontractors for notification and their accounting purposes.
4) Fields/checkboxes that are labeled “Order Assigned”, “Assigned to Notary”, “Order Completed”, and “Order Completed No Invoice” are used to determine which notification emails are to be sent per order.
5) A customer can request a specific, trusted notary be assigned to an order.

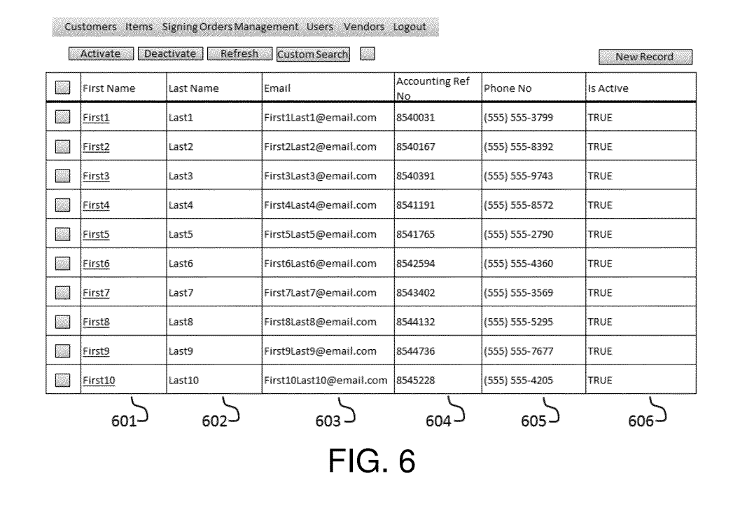

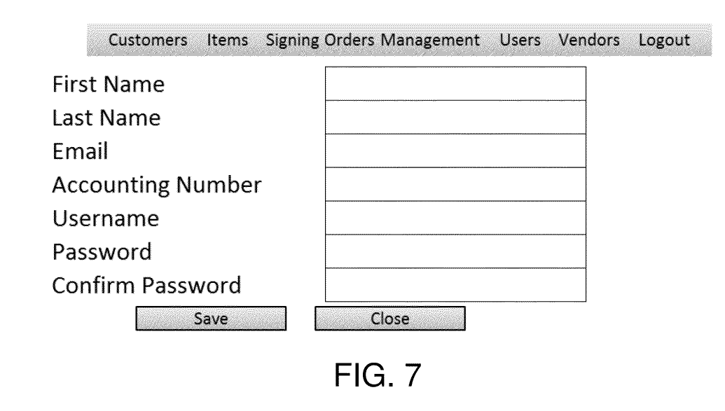

FIG. 6 shows the administrative screen for vendors. There are a number of fields for the vendors including contact information such as first name 601, last name 602, e-mail 603, accounting reference number 604 for coordination with accounting software, and the phone number 605. An active (true/false) field 606 is included to indicate the status of a vendor—true means that the vendor is active and can be used for signings. Additionally, there is an activate button which makes the vendor active (if they are not), a deactivate button, a refresh button to reload the page and confirm any changes, a convenient custom search button to allow the user to locate vendors, and a new record button which brings up a form for adding a new vendor (see FIG. 7).

In another embodied feature of the invention, the vendor information is automatically passed through to separate accounting software by use of a computer program. The data input by the vendor is mirrored in the accounting software. Typically, the data exchange is done by an export file from the central computer to the accounting software.

FIG. 7 shows the vendor input screen. The fields are entered by the administrative staff and saved. The Close button is used when viewing the screen but not changing the data. Each notary uploads their own certificates and W-2 tax form information to their profile. This allows the administrative staff to:
1) Maintain vendor records for compliance certifications, ensuring up to date tax information, ensure compliance to releasing information documents, and approval for receiving work orders.
2) Upload documents specific to the Vendor Profile for access and secure archiving.
3) Automatically block vendors from signings that require certain compliance from the customer.
4) Assign vendor specific notes which are required to be reviewed by administrative staff when entering orders. Notes can be added for assistance in certain situations, such as multilingual Vendors, whether a vendor can travel long distances (or not), or noting that a vendor's methods and temperament are unsuitable for a particular order.
5) Lock out any vendor from the central computer system.

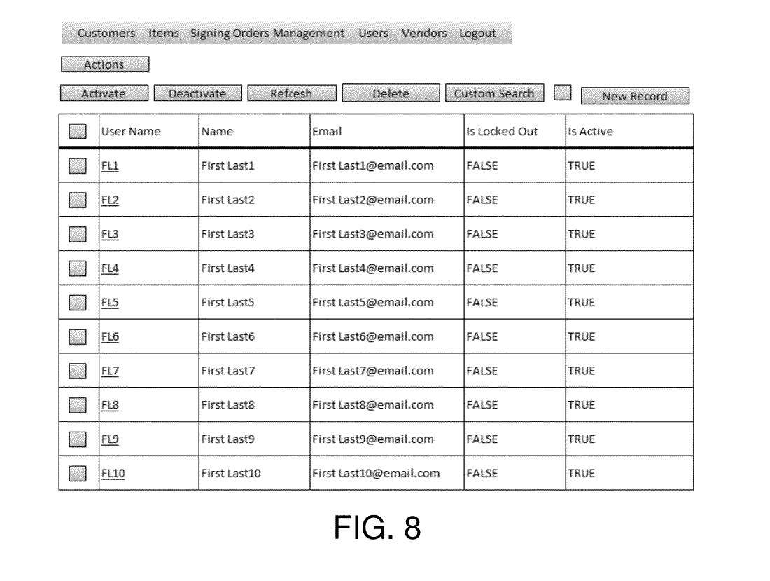

FIG. 8 is the administrative screen for all users, including Vendors such as notaries, Administrative such as administration staff, and Customers such as Escrow Officers, loan officers, and attorneys. The user name may be selected (as seen by underline) and this will display a PopUp window allowing the user contact information and role (permissions) to be assigned. The software provides protection from other malicious software or persons attempting to illegally procure sensitive information. If a login by a person or a malicious program is attempted incorrectly three times, the user will be flagged as “locked Out” and access to the central computer through that login will not be available. This will then require the administrative staff to open the user profile and deselect the “Is Locked Out” check box in order to grant access for that specific login (i.e. computer ID). If the user is flagged as a “False” in the “Is Active” field, then the user cannot be applied to a vendor profile or a customer profile. Additionally, it is a protection from duplications concerning login user names and e-mails.

The features in FIG. 8 allow the notaries to access documents and complete the order. Also it allows the Escrow Office to place an order and upload documents. On the order screen, there is a link (not shown) so even non-registered users can place an order.

Various abilities to activate, deactivate, delete, and create a new record for users are included by using the buttons at the top of the screen. A custom search is included that allows a User to be found quickly according to search criterion. A refresh button is available to re-load the screen and verify any changes. If a user forgot their password, clicking the actions button sends two e-mails. The first e-mail contains the username and the second e-mail contains the password. The e-mails are sent separately to provide important security. In addition to the two e-mails, the users receive a suggestion to change their password.

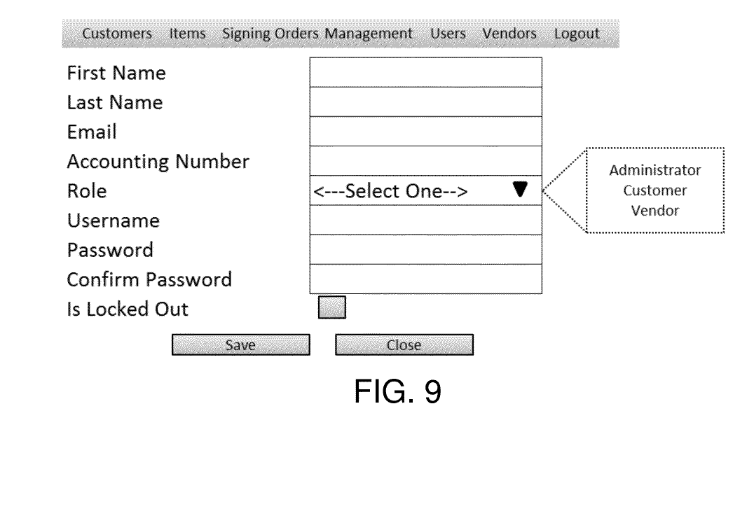

FIG. 9 is an input screen for new users. The fields shown in FIG. 8 are included. The role includes ‘Administrator’, ‘Customer’, and ‘Vendor.’

The documents associated with a signing appointment are delivered by hand/courier from the Signing Agent to the Signing Company office. From there, the document is received and logged, and then forwarded to the Title Company (or EO). Normally, the documents are sent to the Title Company, and out of county signings are typically sent via priority overnight mail to speed delivery and timeliness.

Typically, the notary keeps their own personal schedule for any signing appointments. In another embodiment of the invention, each notary keeps a personal calendar on the central computer. Having a central schedule for all notaries is helpful in identifying which notaries can be assigned to particular signing appointments. In an embodiment of the invention, the central computer system is employed to schedule notaries, and each notary identifies blocks of time in their schedule when they are available for signing appointments. The Notary can then be scheduled automatically based on the online calendar, and when they are not available, their name won't appear in the list of available notaries in a convenient drop down box. In an alternate embodiment, the notary has the option of being automatically scheduled or not by selecting a check box. In a further embodiment, the notary selects the criterion on which the notary will allow automated scheduling. For example, a radius within a zip code area may be one criterion that a notary may use along with how many signing appointments per day that are allowed.

In another embodiment, as a convenience feature, instead of phone call, the notary receives an e-mail with appointment, mobile text message, and an attachment that allows a personal calendar to be updated by simply clicking on the attached signing appointment time. In still another embodiment, any change to a field related to an appointment will result in an automatically generated text or email which is sent to the notary. For example, if the time of an appointment changes, the notary receives an update from the central computer.

A notary signs up at the central computer by giving identifiable information as well as e-mail, phone numbers, and addresses for payment or shipping. Additionally, the notary can upload copies of necessary certification documents.

The notary is assigned to an order by the Signing Company via the central computer or by direct contact via texting/e-mail/phone (TEP). Once the notary accepts the signing appointment date, the notary awaits notification that documents are available for the appointment. When the documents are available, the notary is notified via TEP, and then is responsible to receive the documents via a pickup, or download and printing. The notary has the responsibility to print all the documents cleanly and use the correct paper size (normal 8.5″×11″ and legal) and bring them to the signing appointment. Frequently, attached documents are not sorted by paper size, and the correct paper size is often important to be accepted by the Title Company, Bank, and County Register's Office. Once the documents are downloaded, the documents field on the administration screen changes color (i.e. changes appearance via color coding) to notify anyone viewing the work order record that the documents have been downloaded. Importantly, the document download status is viewable by a customer.

Texting, or text messaging, is the act of composing and sending electronic messages between two or more mobile phones, between two or more portable devices, or between a fixed device and portable devices over a network, such as a phone network or the internet. Texting would include Short Message Service (SMS) communication. It would also include messages with hyperlinks and attachments such as pictures, files, video, and audio cues such as how to properly print documents.

As a convenience feature, when the notary logs onto the central computer to download documents, a check box is added to the notary download screen that combines and downloads all of the documents associated with the file, rather than each file separately. Another check box is added that allows the notary to presort the documents by paper type so that legal and normal documents can be printed in order. This provides a convenience feature for the notary so that each form is on the correct paper size when a printer is used that does not have multiple paper size bins. Another check box adds an automatically generated document which lists the order in which the papers are to be presented at the signing so that the signing appointment goes smoothly, and the EO receives the documents in the correct order. Also, a convenience button is added which shows the notary how many pages have to be printed out so that the notary is clear as to the number of pages have to be brought to the signing appointment.

The notary is assigned by the Signing Company to an order, and is the Signing Agent (representative) of the Title Company.

The EO is responsible to collect and create the documents to be signed at the signing appointment. The EO sends out the documents be signed at the signing appointment via mail, e-mail or by uploading an electronic copy (such as a pdf file—Adobe portable document format) to the central computer. Sometimes a courier is given the task of picking up the documents from the EO and delivering them to the Signing Company.

At the signing appointment, the notary verifies that all the documents are signed properly, and are notarized correctly. Any mistake can cause recording problems and may create delays. A delay can cause a loan interest rate to change if the document has to be corrected later, and it is not timely done. It can also incur additional fees and interest that will cause disputes among the parties. The documents must have signatures, dates when signed, and initials where appropriate on all documents/forms where needed.

Timeliness is critical for returning documents after signing and returning to the EO/Title Company.

The notary is trained for each type of closing such as Real Estate, Car Loan, Personal Loan, etc. Typically, when the notary is the Signing Agent for the Title Company, no Title Company officer is present at the signing appointment.

The EO will typically review the signed documents if present at the signing appointment. Signing problems do occur and must be rectified in a timely manner. After the signing appointment is done, the Notary walks away with all the signed documents and submits them to the Signing Company which forwards them to the Title Company or EO as directed by the EO. In the overwhelming majority of the time, the actual documents (original ink signatures) must be sent to the EO or Title Company. In some cases, the documents are scanned in by the notary and uploaded to the central computer and then is available to the Title Company or EO to access through a secure connection to the central computer. The Title Company and EO can then review the documents immediately for errors, and inform the notary as to possible corrective action. This will help to improve the error rate of documents and maintain timely submissions.

The invention allows the administrative staff to send automated e-mails to the EO when particular stages of the order are completed such as: “Order Received”, “Order Assigned”, and “Order Completed” which includes the invoice for the transaction. In addition to the e-mails, the EO can review the order in the central computer to determine if the documents have been downloaded by the notary.

The EO always works for the Title Company.

It is a legal requirement that a Certified Notary is used for the verification of identities of the signor and verify that the signor put pen on paper when signing. The EO is a third party that is legally required to manage fund disbursements.

After the signing appointment is done and the documents have been properly disposed by the Notary, the Notary then completes (closes) the order by clicking on a link that has been provided by the central computer in the order confirmation e-mail. The notary logins onto the central computer utilizing a password and clicks on another link that notifies the central computer that the signing is completed (as far as the Signing Company is concerned.) This additionally causes an invoice to be automatically generated for the Signing Company, an invoice to be sent to the EO, removes the work order from the administrative screen open work order list, and sends the work order record to an archive. Administrative staff also has the ability to complete the order so that an invoice is created.

Banks require an image of the signor's identification in order to release funds (such as loans or payments). Every signing has this requirement. Most banks require that the image be shared securely so as to avoid identity theft. Most notaries and EO's do not have a simple way to encrypt the image and then send. The advantage of the invention is that the notary uses the central computer to complete this action and both the notary and EO do not have to worry about compliance. Additionally, the images are kept within the specific order and are automatically labeled as to the type of file.

The notary can utilize a web enabled mobile device, such as a phone or tablet computer, with a camera and capture an image of a signed page. Also, the notary can take pictures of IDs and other documents and securely upload them to the central computer. Use of these methods is a very convenient feature for a notary. This avoids the use of a photocopier/scanner, the need to encrypt and save the image to a local computer, and then email the document to the customer. When an image is uploaded to the central computer, it automatically labels the file and associates it with a particular order.

The notary is responsible to securely upload the Identification Documents (IDs) into the central computer. Alternately, the notary informs the central computer that the IDs are included in the original, signed document package by checking a box on the close order screen. Some orders accept paper photo copies of the IDs and others accept uploaded pictures of the IDs. In either case, the central computer is updated by the notary as to how the IDs are submitted. To close a work order, the notary must upload the IDs or check a box that the IDs are with the signed documents. The IDs are usually scanned in and then uploaded into the central computer. Alternately, the IDs are captured by a camera in a phone and then uploaded to the central computer via a secure hyperlink login. The completion report received by the EO automatically notifies the EO as to whether the IDs are with the documents or available to download.

The central computer monitors documents for being scanned in and uploaded, but does not check on the types of documents scanned in and verify that the documents are complete. After the signing appointment, it is up to the notary to ensure that all documents have been uploaded when directed. Similarly, the EO is responsible to ensure that the needed documents are uploaded.

Administrative staff has the ability to mark a file with a convenience button when the scanned documents are required. Sometimes a lender does not need ‘ink signature’ signed documents, and will accept scanned and uploaded documents. A convenience button on the order screen sets up the notification to the notary as to how the documents are handled. Some loan companies will fund a loan with scanned documents and some will not.

When the notary choses to complete an order, this generates the invoice.

The Signing Company may manage 20-25 notaries locally and an even larger number across the US. Time is money due to the number of volume of closings per day and the multiple tasks that it takes to complete each one. Savings steps in the signing and completing process is critical to efficiency, along with accuracy. The computer system is also set up to control security for the individuals involved, as well as being CFPB (Consumer Financial Protection Bureau) compliant.

To that end, a secure communication link with encryption is used for document and ID transfer to ensure that security is built into communications. Password encrypted e-mails from the EO are no longer necessary for security. A login ID with a password allows secure communication for download/upload of documents, and secures transmission of IDs. The communication between users and the central computer utilize a secure protocol such as Hypertext Transfer Protocol Secure (HTTPS). Documents are not sent through un-encrypted e-mail.

The individual documents are not encrypted, so the upload/download of documents is done vie a secure connection with the central computer. It is an important feature to ensure that the documents are secure and eliminate multiple troubles with actually securing the documents themselves with password encryption and sending via un-encrypted e-mail. The user experience when employing encrypted e-mails is frustrating, slow, and often does not open. This is due to the number of passwords and problems with successfully opening the documents caused by different software and software revisions utilizing new features.

When a notary is assigned to an order, the central computer causes the following steps to occur:
A) The central computer sends an order summary e-mail to the Notary, and sends an order confirmation e-mail to the customer. The e-mail to the notary includes:
   i) Information related to the signing appointment: time, location, parties involved, contact information.
   ii) If the customer has uploaded the documents with the order submission, the order confirmation to the notary will include a link to the documents that are accessible with their user name & password.
   iii) If the customer uploads the documents after submitting the order, the notary will receive an email triggered by the documents being uploaded and the email will include a link to access the documents with the notary's user name and password.
   iv) The order summary to the notary always includes a hyperlink which gives the notary the ability to complete (close) the order. This action automatically sends the customer the completion report & invoice, and the order is automatically removed from the admin screen and placed in a completion folder.
B) If additional documents are uploaded later by the EO; a second e-mail is sent to the Notary which includes a link to download the additional documents.

When it is time for the notary to close the order, the notary:
i) clicks on the ‘close the order’ hyper-link in the order confirmation e-mail (or mobile text communication) previously sent
ii) logins to the central computer utilizing a password and goes to upload/IDs
iii) completes the required ID document upload (or checks the box that the ID images are being sent with the signed documents).
iv) uploads any documents that are required to be uploaded.
v) then clicks on button that closes the order.

Note: The administrative staff can check a box that allows the document scanning requirement to appear.

In an embodiment of the invention, the notary cannot close the order unless all of the critical data fields are filled in. For a real estate example, the owners name, the file number, the bowers name, and property address must be filled in the close order screen in order to close an order. Any of these fields with a “?” will stop a work order from being closed. The place holder character “?” in a critical field does not allow an order to be closed, letting the notary know that it has to be updated. The notary can then proceed to fill in any critical field(s). Other closing types have other critical fields.

In an alternate embodiment, the notary closes the work order by clicking on a hyperlink that is associated with an escrow number and clicking on a hyperlink to upload said documents.

If an EO schedules a signing appointment, the EO is primarily responsible for scheduling the signing date or working with the Signing Company to schedule the closing date of a real estate property. To do this the EO:
i) logins to the central computer via a web browser
ii) fills out the database form including the time, place, and attending parties. The EO must include the
   a) customer name,
   b) escrow number, and
   c) signing type (auto, real estate, etc.)
      If an EO cannot provide the above information, a work order will not be accepted into the central computer system. The EO is then notified which required fields need to be completed to place an order.

In an embodiment of the invention, the order process for the customer is kept as simple as possible, while permitting the admin to allow for many variables. For the customer, only 3 critical fields are required to submit an order. Customers can always place orders via phone or email in which case the admin would enter the order into the central computer. The admin has the ability to review the order for proper coding for specific order types, certain fees for particular customers, and adjust payments for particular notaries.

The customer is presented with a short list for simplicity, but the signing company is allowed to choose from many options for administrative purposes. For the admin, there are many signing types and fees vary depending on the type of signing and the customer. Some typical signing types include refinances, loan and cash purchases, seller signings, in state and out of state signings, single documents, and contract rates.

When the order is completed, the customer receives a closing confirmation email which includes the invoice and a notice to the customer that states if the copies of the IDs are attached to the signed document package, or the copies of the IDs are available for download from the central computer. It is no longer considered secure to email a copy of the IDs to the customer.

The Notary is normally charged with the responsibility of printing out the documents for the signing appointment, and also bringing them to the signing appointment. Alternately, the EO can print them out and bring them, especially if it is an ‘in office’ signing, meaning that the signing appointment will be located at the Title Company.

If there are documents that will be uploaded for an order, the uploaded documents are tracked at the Signing Company via the central computer system to verify that they have been uploaded by the EO and then downloaded by the notary (via color coordination on the administrative screen). However, as just stated, uploaded documents may not be needed when there is an ‘in office’ signing. Importantly, to facilitate entering information to the central computer and acting upon available information:
1) Uploaded documents are not required to schedule signing appointment
2) The EO can edit the work order, upload new documents, reschedule the signing appointment, and place an order on hold.

Significantly, the work order record contains multiple note areas that are viewable by different parties. The administrative staff can update a note that is viewable by the Notary, but not the customer. Such notes are routine communication such as negotiations for signing appointment changes or alternate phone numbers to reach a party. A note can be altered so the EO gets an e-mail with the new note or a note on a work order can be added (or changed) without the EO getting an unnecessary e-mail.

| Note Area | Admin Views | EO Views | Notary Views |
|---|---|---|---|
| Note Area 1 | Yes | Yes | Yes |
| Note Area 2 | Yes | No | Yes |
| Note Area 3 | Yes | No | No |

In an embodiment of the invention, the order is as simple as possible to fill out and change as well as being secure. To that end, the EO must use the data field form to submit an order (also can e-mail a filled form or phone the order in). The initial order data is scanned for accuracy and problems that can be found, such a particular signing type, or inputting an assistant's name rather than the EO's name. To that end, the Signing Company will be responsible to catch gross errors by personnel monitoring and correcting necessary information.

Often, the EO is presented with simple choices on a short list window to improve accuracy, but the Signing Company is allowed to correct the order and improve upon it by fine tuning the order type to ensure the invoice amount is correct for the signing type. There are many signing types, and the fees vary for each type. Some typical signing types are loan signings, signing type based on a company (fee differences), loan signing, cash purchase signing, in and out of state signings, single document signing, and auto loan signing.

The EO then receives a confirmation in an e-mail and any notes via TEP and is notified whether or not that the IDs are included when the notary uploads the documents for an order. The IDs can be included in the main document upload, or included with the signed documents. The order completion e-mail informs the EO where to find the IDs.

The software monitoring system is based on scheduling the Signing Agents (qualified notaries) to a particular signing appointment via a work order and monitoring progress of the documents which are executed (i.e. signed) at the signing appointment to be returned to the Title Company.

To this end, an order has to coordinate with an EO who puts in the order. The EO then receives a verification e-mail that the order was successfully received. The Signing Company then calls/texts/e-mails the notary to schedule the signing appointment. The communication is by TEP. Once the notary accepts the work order by TEP, the Signing Company administrative staff assigns the notary to the order in the central computer system. The central computer software includes a notary assignment verification PopUp screen that allows the administrative staff to check yes, and then the notary is formally assigned to the order. If the verification is not done, the notary is not assigned. If a new notary needs to be assigned to the Order, the administrative staff can delete the notary from the order and assign a new notary to the order. To do this, the administrative staff can re-open the order via a convenience button and reassign it. Once a notary is assigned, the central computer system sends an e-mail confirmation to the notary along with signing appointment details, including the EO contact information who the notary will work with. Additionally, a copy of the assignment is sent to the EO which includes notary contact information.

The orders are tracked by color coding on a tracking screen. For example,

| Order Status | Color |
|---|---|
| New order - notary not assigned | Blue |
| Administrative Staff working on order | Red |
| Notary assigned to order | Green |
| Order is on hold | Yellow |
| Completed order | White |
| Archived order | Orange |
| Document field color when documents not | Red |
| uploaded from the central computer | |
| Document field color when documents | Turns from |
| uploaded from the central computer | Red to Black |

Typically, the effort to match a notary to the order is completed within a few minutes, but can be as long as a business day. A data field is included that can be marked to identify the administrative staff person working on the work order. This convenience allows the administrative staff to see who is working on a particular work order without having to open the vendor screen. The administrative staff person assigned to the order is chosen by the Signing Company management team or a person identified as the head scheduler. Often there is a difference between in state and out of state signing appointments. The administrative staff will be familiar with different contacts, based on the state for the closing, and usually a staff specialist is employed that is familiar with out of state signing appointments. To that end, the Signing Company management team will normally assign a different administrative staff person that is familiar with the state of the signing appointment.

The administrative staff person that is assigned to Order will handle the recruiting of the Notary and reaching agreement as to the signing appointment schedule.

In an embodiment of the invention, a point rating for the notary is used to favor one notary over the other. For example, a higher rated notary will be listed first in a search of notaries for certain orders or geographical locations. In one embodiment, the geographical location is defined by a zip code and an associated radius around the zip code. Criterion for rating can include: prompt return of documents, error rates for document signing, signing appointment attendance rate, number of valid complaints about services, and meeting deadlines, among others. A higher rating will allow the notary to receive offers for a larger amount of signing appointments, along with preferable ones. In another embodied feature of the invention, a notary may be flagged in their record that they are not to be used in an assignment. This is helpful if there is a problem with the notary that needs to be resolved. This information will be available to the administrative staff if they attempt to schedule the notary.

A bar coding system is conceived in another embodiment of the invention for use in tracking the documents by using a barcode on the external of the envelope which contains the documents. A barcode is an optical machine-readable representation of data relating to the object to which it is attached. The barcode number can also be used for uploaded documents by entering the number in the central computer system. The bar code, along with a readable number, can be scanned in by use of a mobile device (such as a phone or tablet), and used to keep track of document envelops that are hand carried or mailed. A field in the order is maintained for this. This helps to establish a ‘chain of custody’ for sensitive documents.

The administrative screen for all the orders can be set up to auto refresh or allow refreshing by a manual refresh button. This is helpful when viewing a large and dynamic administrative screen that provides for the orders to be automatically scrolled when new orders, notes, and documents arrive. This feature provides for the administrative screen to be temporarily frozen to allow examination and accurate clicking on the links within the screen.

Another feature of the conceived invention is to provide for a PopUp window warning when a duplicate order has been entered, or attempted to be entered. It can happen that the same order is entered twice by the EO, EO Staff, or administrative staff inadvertently causing two different notaries to be assigned to the same signing appointment. Preferably, the warning screen then generates a flag and the second order is flagged for follow-up by the Administrative staff. This is catchable by the central computer scanning for a duplicate order time that is assigned to the same notary, or for notaries that are double booked for two different orders at the same time.

After EO puts in order, the administrative staff checks and re-edits the order as required. The EO may utilize staff that puts in the order on behalf of the EO, and the fields may not be correctly entered. This often means that the signing type and the name of the EO have to be corrected as the EO staff will often put the incorrect name for the EO.

In an embodiment of the invention, the signing types for the EO are simplified, and the administrative staff later corrects the signing type to a very specific code. This allows the EO work order input type to be simplified so that the EO does not have to learn all the Signing Company work order codes.

In a main embodiment of the invention, the invoice is generated automatically by the central computer. It is desirable to set the invoice number using digits from the order number to simplify record keeping at the Signing Company. In particular, it is the usual case to generate a separate invoice for each order when completed. To that end, the invoice number may be the last five numerical digits from the order number, along with a two or three-digit alphanumeric billing code for the order type. This provides for a convenient check of the invoice amount by looking at the invoice number and cross referencing to the signing type.

Alternately, in another embodiment of the invention, the EO requests a weekly or monthly invoice and the invoice numbers are similarly generated and sent to the EO in a summary invoice format. The EO may also request that an invoice number match the order number exactly. A check box is available for this on the customer profile screen.

In another embodiment of the invention, a re-send invoice button is included on the administration screen on each work order. Also, the EO has the ability to log in to the central computer and print an invoice.

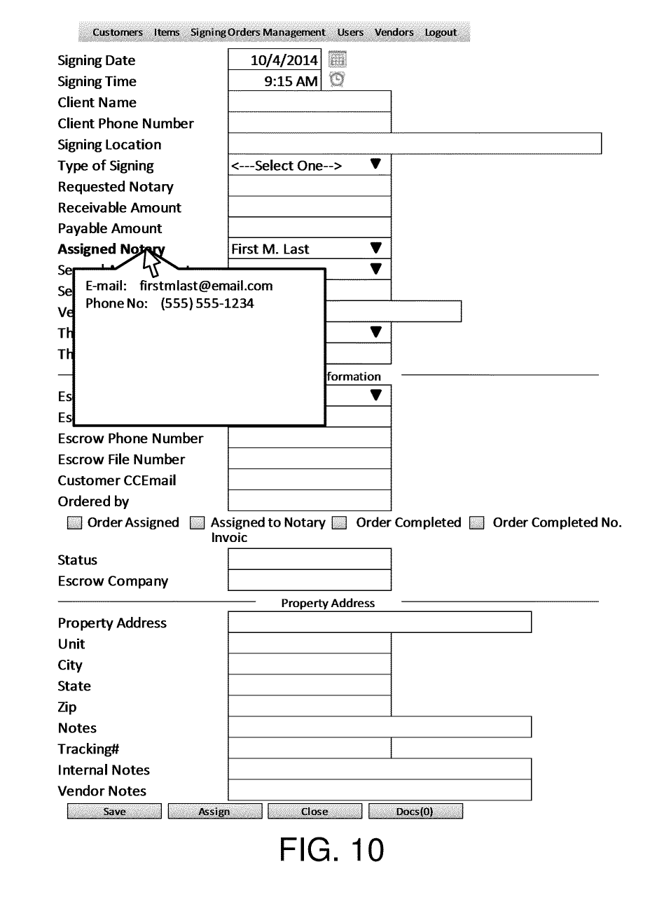

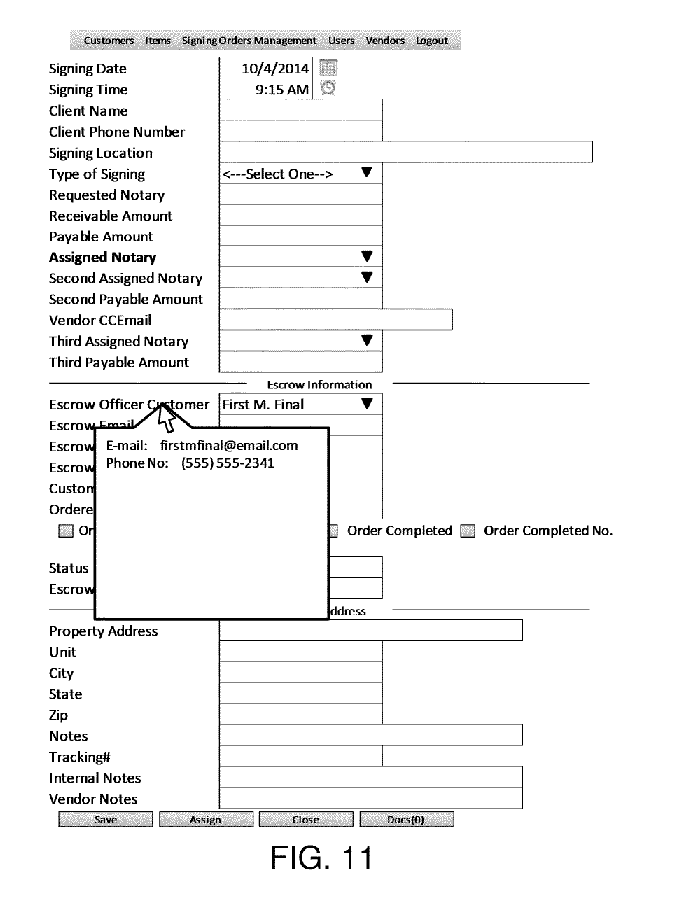

In another embodiment of the invention, when the order is entered into the central computer system, the Order Entry Screen includes convenient features such as
1. A window PopUp that shows EO contact information when the mouse cursor hovers over the Escrow Officer/Customer (See FIG. 11).
2. A window PopUp that shows notary contact information when the mouse cursor hovers over the Assigned Notary (see FIG. 10).

In another embodiment of the invention, when administrative staff monitors the orders on the main administrative screen, the document field is set up to make it ‘easy at a glance’ to determine if the documents have been downloaded by the Notary by utilizing a different color in the document field (i.e. color coded). For example, a document icon in red would mean that the documents have not been downloaded by the Notary. A black field would mean that the documents have been downloaded by the Notary. If the documents are sent via mail, a bold text would mean that the documents have been sent, and vice versa. A button on the administrator screen is available to do this.

In another embodiment of the invention, automated alerts and prompts to the notary and EO are selectable on the order entry screen by a check button. The alerts can be turned off or on depending upon the EO preference and/or an administrative staff decision as to whether or not it is necessary to send or re-send alerts. It is possible the notary (or EO) will need a communication re-sent due to accidental deletion, losing it, etc.

In another embodiment of the invention, any number of e-mail carbon copy (cc) addresses can be added to the order entry screen by a field that allows multiple interested parties to receive e-mail when different fields are updated. For example, it may be desirable for a third party, such as a real estate agent or loan officer, to be included on certain communications between the notary and EO, and for changes to the order. The carbon copy e-mail addresses can be added for either Notary communication from the central computer or for EO communications, or both. This allows interested parties to have the current order status.

In still another embodiment of the invention, an auto fill in feature is added to the order entry screen or search function for the administrative staff. The auto fill feature in watches the text being entered into a field and automatically presents anticipated text that might be used by the person entering the information in a PopUp window. For example, the auto fill in may watch the EO name being typed in and after three or four letters have been typed, search in the background all available EO names and present them to the typist in order of likelihood of need. The typist can then select the desired name from the PopUp window. Other pertinent fields in the order entry field are then automatically filled with text associated with the particular EO selected. If the EO is not selected from the PopUp window, the typist then enters all of the data normally. Similarly, other auto fill in is utilized for other fields in the order entry screen such as for the notary and signing types.

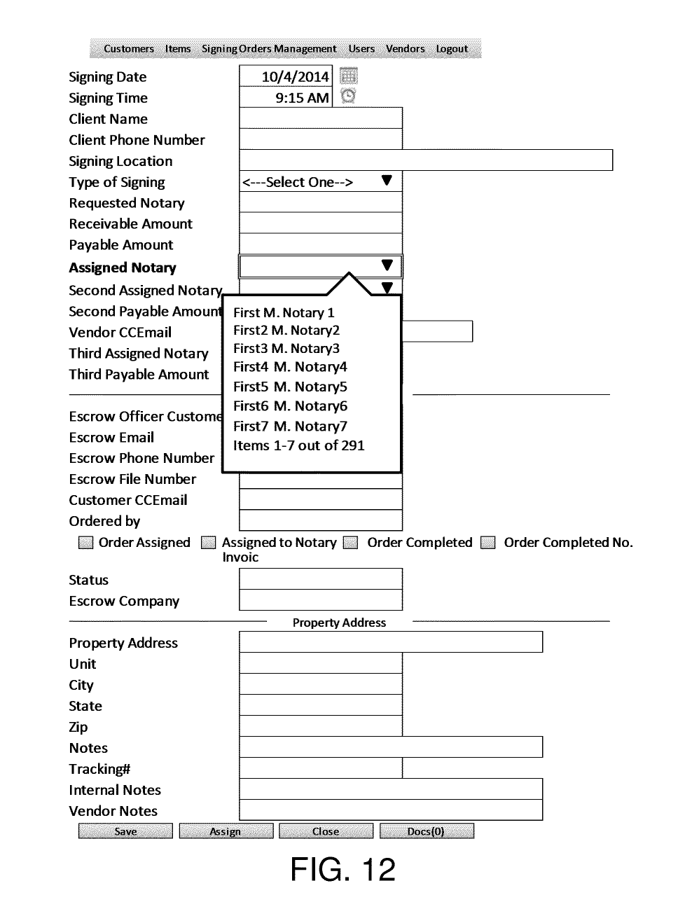

FIG. 12 shows an embodied feature on an input screen for new users where a PopUp window highlighting database choices for the assigned notary is shown by clicking on the small triangle. This is a very convenient feature as all of the known data fields are automatically filled in when the notary is selected from the PopUp window list.

In another embodiment, an order is locked for other users after a first user accesses the order. This prevents mistakes and by preventing simultaneous data updates. A second person who attempts to access a field is not permitted to access the order. A PopUp window is utilized to inform the second user that the field is being used by another user.

In another embodiment, various confirmation boxes are added when entering information in the Order Entry Screen. If an individual attempts to enter the wrong type of text, the central computer then notifies the user that the data is invalid and presents options for canceling or correcting the entry. For example, if a date is desired, and the user miss-enters a year, the computer can recognize the problem and take action to improve the error rate in the order entry screen. Other errors can be similarly corrected, such as a user attempting to enter a notary that is not registered on the central computer system (i.e. does not have a valid login or contact info).

In another embodiment, the administrative staff can inspect the documents associated with a work order without changing the document status. This is helpful when the administrative staff desires to know whether the notary has printed the documents or not.

In another embodiment, searching for information out of the central computer database is made easy by searching all fields in the database. This feature allows the administrative staff to select a particular EO, notary, location, or company for display on the main administrative screen rather than the ongoing orders and their current status. This feature is very useful when administrative staff is working on an order and needs to respond to questions quickly and accurately. It also helps in troubleshooting issues with documents and signing appointments. For example, a search by city and state will show all notaries in a particular geographical location. This can be helpful for quickly finding information to troubleshoot a problem or find a notary for a particular signing appointment.

In another embodiment, the search function is an important way for the Signing Company to be able to receive money from each closing and match the money to the individual order. This provides for high accuracy in billing and reduces mistakes with invoicing such as re-sending an invoice. When money is received that does not have an accurate order number, the search function is used to correctly match the money to the EO by examining the property address or borrower's name.

The administrative staff can open an order (except for archived orders) and make any needed changes at any time. In an embodiment of the invention, the administrative staff can move a completed order (but not an archived order) back to open status. This feature is very useful in the event that a notary closes out the wrong order.

In another embodiment, the central computer system automatically sends alerts to the notary every hour after closing to alert the notary that the order has not been completed and to encourage the notary to quickly complete the order. The communication happens through any of text, e-mail, and automated phone calls until the closing has been completed.

In another embodiment, when an order is archived, it is locked to prevent editing (i.e. changed to read only). Additionally, no documents are archived. They are securely removed by digitally shredding them via deleting and overwriting the file location in the computer where they were located for security reasons as they contain a lot of personal information.

In another embodiment, a vendor search feature is added to the administrative screen. The vendor can be searched by name or zip code, and the zip code can be expanded to nearby zip codes within a defined radius distance. Nearby vendors will then appear in the search, and the searcher can select the desired vendor. The radius can be varied to get fewer or more vendors in the search result and it will display the notary rating (if available). In an embodiment, the higher rated notaries will be listed first.

In another embodiment, a convenience button is added to the administrator screen for common communication needs like: status of an order sent to the EO or a request from a user for contact information. In a further embodiment, the button activates a PopUp menu where the user can select the communication type.

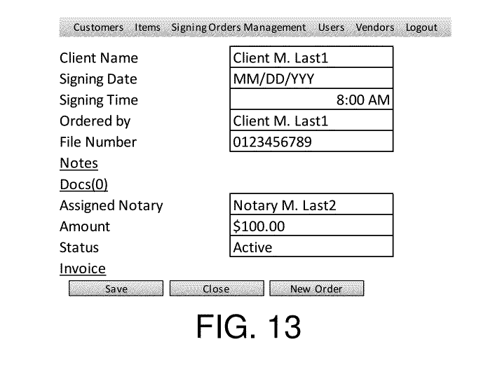

FIG. 13 is a customer screen which is available to a customer, such as an EO, for review of the application status, document, and notes. Available data fields are:
1. Client Name—The information is the most common reference label for any particular orders. It is the signor's name.
2. Signing Date of the order
3. Signing Time of the order
4. Ordered By—This field allows the customer to have an assistant place the signing order and determine that action.
5. Order Number—This information is the reference label for any particular order. On occasion a client will have multiple closings at the same time.
6. Notes—this field is actually a link to view or create correspondence, specific to that individual order, between administration and the customer.
7. Docs—This field is a link to view or upload documents to a specific order. The advantage of this link for the customer is the ability to determine if the notary has retrieved all necessary documents. When new documents are uploaded, being attached to the order, the “Docs” link will display with a bold font until the notary has downloaded all the documents for that order.
8. Assigned Notary—this field is a quick reference pertaining to the notary that will conducting the signing.
9. Amount—This field displays the cost for the order to the customer.
10. Status—this field displays the real time progression of the order.
   a. Open. Received by admin., but not assigned
   b. Assigned. The notary has been assigned, the appointment has been scheduled and the contact information is available.
   c. Completed. The appointment was completed by the notary and the invoice if ready.
11. Invoice—Once the status of the order has reached “Completed”, the customer can download an invoice.

FIG. 13 is specific to a customer and their account. They cannot do anything accept review current orders, review notes or documents, retrieve a completed order invoice, or create a new order by selecting a “New Order” button. The quick access to the invoice is important as the majority of real estate transactions require the invoice to be included in the EO's documents in order to close. Though the invoice is emailed to the EO attached to the “Signing Completed” email, it can easily be deleted or misplaced. This is a major customer convenience.

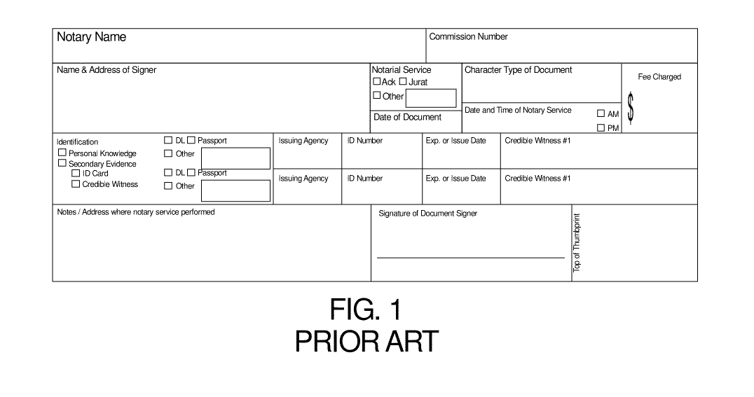

Implementation of the administrative methods and systems as taught in this invention has significantly increased the capabilities of a signing management company. For example, the old record system (FIG. 1) required manually entering every order and keeping individual order forms. The same number of administrative staff that used to handle only 50 signings per day became capable of managing an average of 250 signings per day.

By using administrative alerts and associated features as taught in this invention, the number of mistakes was reduced by roughly 50 percent. Even as the administrative manpower per signing reduced, mistakes significantly decreased. Additionally, customer complaints were cut in half and human error became far less a factor in quality control measures. Documents are never lost, as the methods tightly track the chain of document custody throughout delivery.

Implementation has also improved invoicing. Invoices are sent instantly upon closing, where previously it was normally sent the day following closing. The automated invoicing removed a step in the billing process to allow customers to issue payments faster. Implementation of the administrative methods and systems as taught in this invention has facilitated cost effectiveness in all aspects of day to day operations.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

We claim:

1. A computer-implemented method for signing appointments comprising:
A) providing a database for receiving information related to a signing appointment, wherein said database resides on a central computer system,
B) providing a work order record to be associated with said information related to said signing appointment,
C) providing a user interface to said database, wherein said user interface provides access to said work order record,
D) wherein said user interface includes a web browser to communicate with said database,
E) providing an administrative function related to said work order record, wherein said administrative function includes:
1) updating said work order record,
2) editing said work order record, and
3) providing status monitoring of said work order record, wherein said status monitoring includes color coding,
G) determining automated alerts based on the status of said work order record,
H) providing communication of automated alerts initiated from said central computer system to said user interface from at least one item selected from the group consisting of:
1) e-mail communication,
2) mobile text communication, and
3) phone communication,
I) providing a secure exchange of documents associated with said work order record between said central computer system and said user interface by use of a secure web browser connection,
J) wherein at least one of said documents is notarized at said signing appointment,
K) providing for said user interface to close out said work order record by utilizing a hyper-link provided in an e-mail communication or mobile text communication,
L) additionally providing for said closing out of said work order record to require a login and password, and
M) providing an invoice to be automatically created after said work order record is closed out.

2. The computer implemented method according to claim 1 wherein notes related to said work order record are stored on said central computer system.

3. The computer implemented method according to claim 1 wherein said user interface communicates with said central computer system using a secure protocol.

4. The computer implemented method according to claim 1 wherein an administration screen:
A) monitors a plurality of said work order records,
B) includes at least one item from the following list comprising:
i) a user name associated with said work order record and
ii) an e-mail address associated with said work order record.

5. The computer implemented method according to claim 4 wherein a separate vendor input screen is used for inputting information about a vendor into said database.

6. The computer implemented method according to claim 5 wherein said administration screen includes an ability to lock out any said vendor from said central computer system.

7. The computer implemented method according to claim 1 wherein a centralized schedule for said signing appointments is kept in said central computer system.

8. The computer implemented method according to claim 1 wherein a barcode is added to said documents for the purpose of tracking.

9. The computer implemented method according to claim 1 wherein after said work order record is assigned, said central computer system automatically sends an e-mail communication, wherein said e-mail communication includes at least one item selected from the group consisting of:
i) schedule information related to said signing appointment,
ii) a hyperlink associated with said documents related to said work order record, and
iii) a close order hyperlink for closing said work order record.

10. The computer implemented method according to claim 9 wherein said work order record is closed by at least:
i) clicking on said close order hyperlink and
ii) uploading identification documents associated with said signing appointment.

11. The computer implemented method according to claim 1 wherein said documents are uploaded by:
i) clicking on a hyperlink that is associated with an escrow number and
ii) clicking on a hyperlink to upload said documents.

12. The computer implemented method according to claim 1 wherein a rating system is established for work performed at a signing appointment.

13. The computer implemented method according to claim 1 wherein said central computer system displays a pop-up window notification that a duplicate of said work order record has attempted to be entered.

14. The computer implemented method according to claim 1 wherein said work order record is locked out when more than one said user interface attempts to modify said work order record.

15. The computer implemented method according to claim 1 wherein said central computer system sends alerts every hour if said closing of said work order record has not been performed.

16. The computer implemented method according to claim 1 wherein any archived said work order record is locked to prevent it from editing, and any associated documents are digitally deleted.

17. A non-transitory computer readable medium storing instructions that when executed on a central computer system causes the central computer system to:
A) receive information related to a signing appointment and store said information in a database, wherein said database resides on said central computer system,
B) provide for a work order record residing in said database to be associated with said information related to said signing appointment,
C) provide a web browser interface, wherein said web browser interface allows access to said database,
D) provide for:
1) updating said work order record,
2) editing said work order record, and
3) status monitoring of said work order record, wherein said status monitoring includes color coding,
E) send automated alerts based on the status of said work order record,
F) provide a secure exchange of documents to and from said central computer system by use of a secure web browser connection, and
G) provide an invoice to be automatically created after said work order record is closed out.

18. The non-transitory computer readable medium storing instructions according to claim 17 wherein an administration screen monitors a plurality of said work order records.

19. The non-transitory computer readable medium storing instructions according to claim 17 wherein said central computer system sends alerts every hour if said closing of said work order record has not been performed when scheduled.

20. A computer-implemented method, comprising:
specifically programming at least one computer to at least perform the following:
A) store information related to a signing appointment in a database, wherein said database resides on a central computer system,
B) provide for a work order record to be associated with said information related to a signing appointment,
C) provide a web browser based interface to access said database,
D) provide for:
1) updating said work order record residing in said database, and
2) status monitoring of said work order record, wherein said status monitoring of said work order record includes visible changes to a display of said work order record,
E) send important automated alerts based on the status of said work order record,
F) provide a secure exchange of documents to and from said central computer system by use of a secure web browser connection, and
G) provide an automatically created invoice after said work order record is closed out.
